(19) United States
(12) Patent Application Publication
(10) Pub. No.: US 2019/0173301 A1
(43) Pub. Date: Jun. 6, 2019

(54) WEARABLE POWER SUPPLY

(71) Applicants: Lydia R. Narayanasamy, Hanover, MD (US); Dorothy D. Burdine, Ardmore, TN (US); Lavada S. Pitts, Huntsville, AL (US)

(72) Inventors: Lydia R. Narayanasamy, Hanover, MD (US); Dorothy D. Burdine, Ardmore, TN (US); Lavada S. Pitts, Huntsville, AL (US)

(21) Appl. No.: 15/829,891

(22) Filed: Dec. 2, 2017

(51) Int. Cl. H02J 7/00; H01F 7/02; H01R 13/62; H01R 13/03; H01R 13/627

(52) U.S. Cl. CPC H02J 7/0045; H02J 7/0068; H01R 13/6278; H01R 13/6205; H01R 13/03; H01F 7/02

(57) ABSTRACT

A self-aligning electrically conductive magnetic coupling system provides a mechanically moveable electrical connection for an electrical power source to include a battery or plurality of batteries comprising a battery pack and associated connectivity and controls, and conductive magnetically facilitated power coupling to an appliance. Flexibly mounted magnetic electrical conductors and connectors provide simultaneous mechanical and electrical connection of the electrical power source to an appliance.

### FIELD OF THE INVENTION

The present invention relates to magnetic electrical conductors and connectors, and in particular to the mechanical and electrical connection of a battery electrical power source to a hand held, body mounted or other mounted electrical load. The present invention embodies a self-aligning magnetic coupling system providing a mechanically flexible but controlled electrical connection for a battery power supply, together with a battery or plurality of batteries comprising a battery pack with associated connectivity and controls, and magnetically facilitated power coupling to an electrical load.

### SUMMARY OF THE INVENTION

The present invention reveals a battery connection method facilitating rapid battery exchange. No cabling is involved with mechanical connection and electrical conduction being provided by the magnetic attraction of magnetic conductors, including the electrical attachment and mechanical support of the battery and magnetic and electrical connection to the load. It further provides for reversibility of the battery connection eliminating any possibility of reversed polarity during attachment. It further reveals means for the connection and alignment of conductors with the aligning forces provided by magnetic attraction.

The present invention provides for self-alignment of the magnetic conductive connectors without the requirement for springs or other mechanical implements. It incorporates the retention of the conductive magnetic connector allowing limited but sufficient movement for self-alignment. Further, the present invention facilitates the relief of side loading forces as the magnetic connector has limited freedom of motion without losing electrical contact or mechanical retention.

The present invention relates to magnetic electrical conductors and connectors, and in particular to the mechanical and electrical connection of a battery electrical power source to an electrical appliance and associated electrical controls. The present invention embodies a self-aligning magnetic coupling system providing a flexible connection for a battery, together with a battery comprising a battery pack, and magnetically assisted power coupling to an electrical load.

Unless otherwise defined, all terms (including trade, technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art, and should not be interpreted in an idealized or overly formal sense unless expressly so defined herein. Well known functions or constructions may not be described in detail for brevity and/or clarity.

### DISCUSSION OF THE PRIOR ART

The present invention provides for the rapid removal and replacement of a battery power pack minimizing the break in supply of electrical power to the load. The process includes the removal of the electrically discharged battery pack, the insertion and retention of a charged battery pack, the retention being facilitated by magnetic means, said means further incorporating electrical conduction, and the mechanical provision of degrees of freedom of motion or the battery pack relieving mechanical connection stresses and assuring continuous and assured electrical connection during operation of an electrical load.

The present invention provides a battery pack with a flexible but fixed electrical and mechanical connection means allowing limited mechanical motion of the battery pack without excessive mechanical tension on the electrical connection preventing loss of electrical contact. It also provides for the retention of a control device and the connection to a load. In the case of a hand held or body mounted load such as a power tool the present invention may be mounted on a body part such as the arm, hand or leg. In this manner the battery moves with the body without undue stress on the magnetic mechanical connection maintaining uninterrupted electrical connection.

The present invention provides for the electrical connection and mechanical support of a battery through the electrically conductive plating on the attractive magnets and for a conductive surface between the coupling magnets insuring proper alignment and electrical conduction. Further, the present invention embodies the forming of opposing electrical polarities in the magnetic north and south magnetic fields utilizing the natural attraction of the magnetic fields to facilitate the properly oriented electrical connection. The electrical connection may be of any known type to include Direct Current, Alternating Current, and signal or combined power and signal as preferred for the application. The magnets on either side of the battery pack connection need to be of proper polarity to attract and may all be of the same polarity or be reversed or alternated in respect to each other so as to attract or repel as per the desired operation with or without the requirement for insulating material between the conductors as per the required application. Electrical polarities being so oriented and their connectivity so controlled are a preferred embodiment of the present invention.

In terms of hand held battery operated tools the present invention provides for a battery powered portable system of operating the tool where the battery and associated controls can be worn on the users body or clothing, the battery connecting via conductive magnetic means that further mitigate excessive mechanical motion reducing or eliminating mechanical stress on the electrical connection. The present invention further provides for the electrical connection and mechanical support of a battery through the electrically conductive plating on the attractive magnets and by the electrical conductivity of the magnets themselves providing a captured conductive surface between the coupling magnets insuring proper alignment and electrical conduction. The present invention further provides mechanical flexibility of the magnetic electrical connectors assuring electrical contact by mitigating minor alignment or mechanical contact issues.

The present invention facilitates complete reversibility of the magnetically polarized electrical connection with assuring correct electrical connection at all times in any orientation as it is reversible. The present invention assures contact of the magnetic conductors by separating them with a structural but flexible connective material assuring complete electrical contact at all times.

Mounting the battery on the electrical load adds weight and complexity to the load, such as a power tool. This weight must be supported and moved with the load during use. The present invention provides for the flexible magnetic connection of the battery in a multiplicity of configurations, including attachment to the arm, leg or body further facilitating electrical connection to the tool via a short electrical connector and the convenience of electrical controls being available at the battery at all times. In this manner the present invention provides for no battery weight on the load, such as an electric tool.

The present invention integrates the magnetic and conductive functions and is further integrated with the battery pack forming a single unit providing a connectable battery function that is mechanically supported by the magnetic action of the electrically connecting element. Mechanical flexibility is provided relieving stress on the conductive connective magnets facilitating incidental motion of the battery relative to the connector.

The present invention provides a battery that is not integrated into the load, such as a power tool, but is integrated into the function being performed by the user. Mounting the battery on the power tool adds weight and complexity to the power tool. This weight must be supported and moved with the tool during use. The present invention provides for the flexible magnetic connection of the battery in a multiplicity of configurations, including attachment to the body of the user further facilitating electrical connection to the tool via a short magnetically or mechanically connected electrical connector and the convenience of electrical controls being available at all times.

The present invention further integrates the magnetic and conductive functions and is further integrated with the battery pack forming a single unit providing a connectable battery function that is mechanically supported by the magnetic action of the electrically connecting element. Mechanical flexibility is provided relieving stress on the conductive connective magnetics facilitating incidental motion of the battery pack relative to the connector.

### BRIEF DESCRIPTION OF THE DRAWINGS

The invention will now be described with reference to the accompanying drawings in which:

FIG. 1 illustrates components including a Battery Pack 1, Battery Pack Connector Magnets 2, Band 3, Integrated Controller 4, Power Output Connectors 5, Cable Connectors 6, Band Magnetic Connectors 7, and Cables 8.

FIG. 2 illustrates Battery Pack 1 is shown with three Battery Pack Connector Magnets 2, Power Indicator 9, Low Voltage Indicator 10, and Battery On/Off Switch 11.

FIG. 3 is an electrical schematic of Battery Pack 1.

FIG. 4 illustrates the Strap 18 attached to the Band 3 with extensions to facilitate wrapping around the retaining structure, such as an arm or leg retaining the Band 3.

FIG. 5 illustrates a cross section of a Battery Pack 1, Band 3, Strap 18, Body Part 19, Integrated Controller 4, and a Power Output Connectors 5.

FIG. 6 is a functional diagram of the relationship between the various components in terms of electrical and electronic flow and connection.

FIG. 7 illustrates the Power Output Connectors 5 mounted on the Band 3 just prior to contact with Cable Connector 6, here shown further comprised of Cable Connector Magnets 16, Power Switch 20 and Power On/Off Indicator 21.

FIG. 8 details the Cable Connector 6 components Cable Connector Magnets 16, Power Switch 20, Power On/Off Indicator 21, Cable 8, and Load 17, and their electrical connections to each other.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention relates to the mechanical connection of electrical power and a load through conductive elements by action of integrated magnetic elements and associated controls. In particular to the conduction of electrical current via conductors brought into mechanical contact by integrated magnetic elements to power a load.

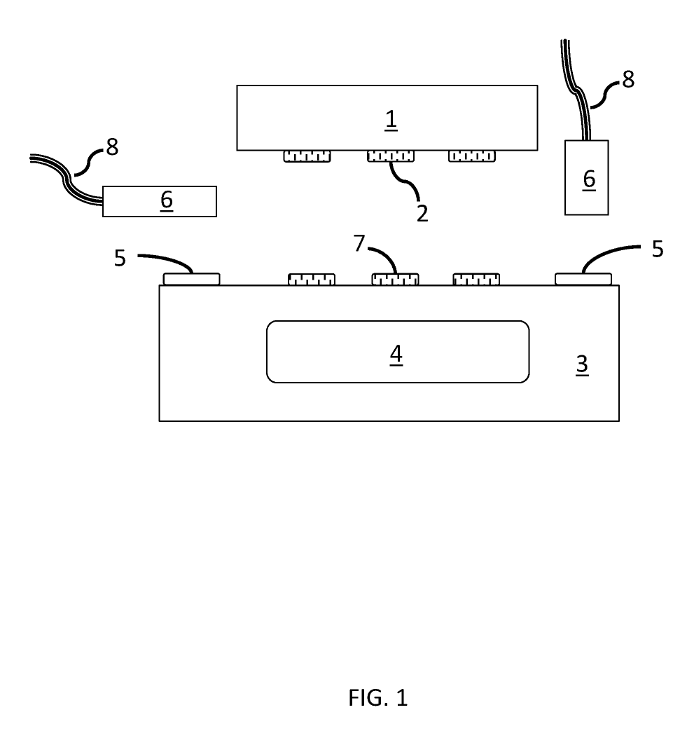

FIG. 1 illustrates the principal components of the present invention. It is comprised of the individual components including a Battery Pack 1, Battery Pack Connector Magnets 2, Band 3, Integrated Controller 4, Power Output Connectors 5, Cable Connectors 6, Band Magnetic Connectors 7, and Cables 8. The Battery Pack 1 is comprised of batteries, not shown, with integrated electronics, controls, condition indicators and power regulation.

The Battery Pack 1 supplies electrical power through Battery Pack Connector Magnets 2 to Band Magnetic Connectors 7. The electrical power supplied is AC or DC at a voltage and a current as required, and in the case of AC at a frequency as controlled by the Battery Pack 1 integrated electronics and power regulation.

Battery Pack Connector Magnets 2 and Band Magnetic Connectors 7 are electrically conductive magnets. They are arranged in a line and their electrical and magnetic polarities are selected to provide a correct electrical connection even if the mechanical connections are reversed. This means that the Battery 1 may be removed, turned one hundred and eighty degrees around (reversed) and reconnected without changing the electrical connection. It is a preferred embodiment of the present invention that the outermost magnets, located at the first and third position of the line of magnets, be of the same magnetic polarity on their exposed side away from the Battery Pack 1, and that the center magnet have an opposite magnetic polarity on the exposed side away from the Battery Pack 1. It is a preferred embodiment that the magnets of the Battery Pack 1 are arranged to be of the opposing magnetic polarity to facilitate the magnetic connector to Band Magnetic Connectors 7.

In this manner the electrical polarities will always orient properly regardless if the Battery Pack 1 is attached in either direction. The present invention integrates the magnetic and conductive functions and is further integrated with the battery pack forming a single unit providing a connectable battery function that is mechanically supported by the magnetic action of the electrically connecting element.

The Band 3 facilitates the wearing of the present invention on an object such as an arm or leg, and houses Integrated Controller 4 while providing for the electrical output Power Output Connectors 5, along with the magnetic mechanical and electrical connection of Battery 1 by Band Magnetic Connectors 7.

The three conductive magnets of Battery Pack Connector Magnets 2 are aligned to intersect with conductive magnets Band Magnetic Connectors 7. Conductive magnets are chosen with a magnetic orientation to facilitate the desired mechanical connection with the conductive magnets of the connecting component. For example, conductive magnets may be oriented such that all conductive magnets present the north magnetic pole with respect to the connecting conductive magnets. When conductive magnets are brought together they attract each other and mechanically contact forming an electrically conductive connection. In this manner the assemblies will connect in any direction and can be aligned such that only one, two or all three magnetic actions of each assembly contact the magnetic actions of the other assembly. This may or may not be desirable depending on the application. Many other combinations and connection orientations are possible and are included as preferred embodiments of the present invention.

The Band 3 is preferred to be comprised of a flexible material suitable to be worn on the arm or leg, both preferred embodiments. Flexible materials suitable for the present application are wide ranging. Examples of synthetic fabrics include such items as polyester, neoprene including foamed material, acrylic, nylon, rayon, PVC, polypropylene, acetate, spandex, orlon (an Acrylic fiber) and Kevlar (an Aramid fiber), and many others. Examples of natural fibers include all plant and animal fibers used to produce a yarn or cloth. In this manner it can be attached with a strap (not shown). These and other similar materials are preferred if the Band 3 is sewn into or otherwise attached to clothing. Harder or stiffer materials are a preferred embodiment for mounting on a surface or containment as is suitable to the situation.

Band 3 is preferred to be configured for attachment to objects such as a hat, helmet, tool or vehicle as required for the particular use or application. It is a preferred embodiment that Band 3 provides a contained space for electronics.

The Integrated Controller 4 provides both user interface and electronic power control. As shown, Integrated Controller 4 is preferred to be configured as a touch screen integrated with or attached to Band 3. Band 3 further contains associated electronics as accommodate the desired configuration and function. Integrated Controller 4 provides the user interface to control the electrical potential, current regulation and frequency of the electrical output presented at Power Output Connectors 5. Integrated Controller 4 is preferred to contain all the required electronics interfacing with Battery Pack 1 and Power Output Connectors 5. Integrated Controller 4 may also be configured as a display and manual control, such as a knob or knobs controlling electronic devices such as a potentiometer contained within Integrated Controller 4 or within Band 3. Integrated Controller 4 receives electrical power from Battery 1, converts and controls that power for use in terms of voltage, current and frequency as configured, and provides that power to Cable Connectors 5.

The Power Output 5 is preferred as a conductive magnetic array of one or more conductive magnets. It provides the power output as controlled by the Integrated Controller 4 from electrical power provided by the Battery Pack 1.

Power Output Connectors 5 is preferred to be comprised of three conductive magnets arranged in a side-by-side order such that the outermost magnets are presenting the same magnetic and electrical polarity that is the opposite magnetic and electrical polarity of the middle magnet. The polarities are chosen to facilitate magnetic and electrical contact with Cable Connector 6.

The electrical power supplied by Battery Pack 1 through Battery Pack Connector Magnets 2 through Band Magnetic Connectors 7 and controlled by Integrated Controller 4, is output to Cable Connector 6 through Power Output Connectors 5. In this manner the controlled power is furnished through Cable 8 to the electrical Load 17 not shown.

The Cable Connector 6 is preferred to be comprised of three conductive magnets arranged in a complementary order both magnetically and electrically to facilitate mechanical connection with Power Output Connectors 5 and provide the desired conduction of electricity through Cable 8 to the electrical Load 17 not shown.

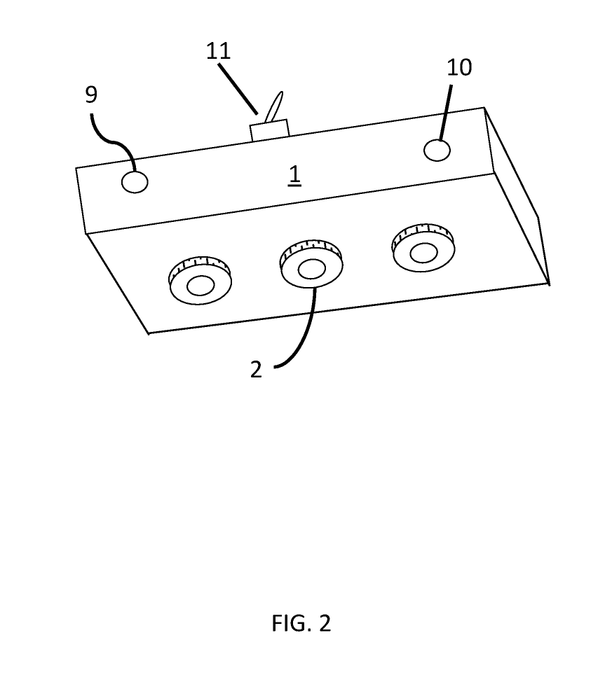

FIG. 2 illustrates Battery Pack 1 and is shown with three Battery Pack Connector Magnets 2, Power Indicator 9, Low Voltage Indicator 10, and Battery On/Off Switch 11. The Battery Pack 1 is shown as preferred housed in a non-conductive enclosure. This enclosure may be a box or may be a conformal coating of sufficient strength to maintain Battery Pack 1 as a unit and protect the contained battery and electronic elements from damage. The conformal coating is preferred to be durable and surfaced (such as rubberized) to accommodate handling and wearability.

The Battery Pack Connector Magnets 2 are preferred to be coated or housed in a conductive cladding material that is preferred to be mechanically sound and highly electrically conductive. Preferred materials comprising conductive cladding material include all conductors without restriction such as gold, silver, copper, nickel, aluminum and any conductive metal. Carbon, conductive plastics and compositions containing conductive materials are also preferred. Conductive rubberized and elastomeric materials and composition materials providing a conductive path are also preferred as an improvement in the mechanical durability of the conductive cladding material.

The Power Indicator 9 is preferred as an audio, vibratory or light-emitting indicator. It activates when the Battery Pack Connector Magnets 2 are energized by Battery On/Off Switch 11. Optionally, in the case where Battery On/Off Switch 11 is not integrated, the Power Indicator 9 is either not integrated or is configured to activate when current is conducted through Battery Pack Connector Magnets 2. When the Power Indicator 9 is configured as an optical indicator, the Power Indicator 9 is preferred to be a Light Emitting Diode, hereinafter referred to as an LED, as these devices are robust, water tolerant, low cost and in wide use. When the Power Indicator 9 is configured as an audio indicator technologies such as piezoelectric audio emitters are a preferred embodiment. Any optical, vibratory or audio indication or indicator is a preferred embodiment, the prevailing selection factor being the particular use of the present invention.

Low Voltage Indicator 10 is preferred as an audio, vibratory or light-emitting indicator. It signals when the Battery Pack 1 voltage approaches or reaches a pre determined low voltage level. Low Voltage Indicator 10 may be digitally activated to an electrically on state at a determined voltage level or may function in an analog manner signaling with a small signal at first then stronger as the pre determined voltage level is reached. When the Low Voltage Indicator 10 is configured as an optical indicator, the Low Voltage Indicator 10 is preferred to be an LED. When the Low Voltage Indicator 10 is configured as an audio indicator technologies such as piezoelectric audio emitters are a preferred embodiment. Any optical, vibratory or audio indication or indicator is a preferred embodiment, the prevailing selection factor being the particular use of the present invention.

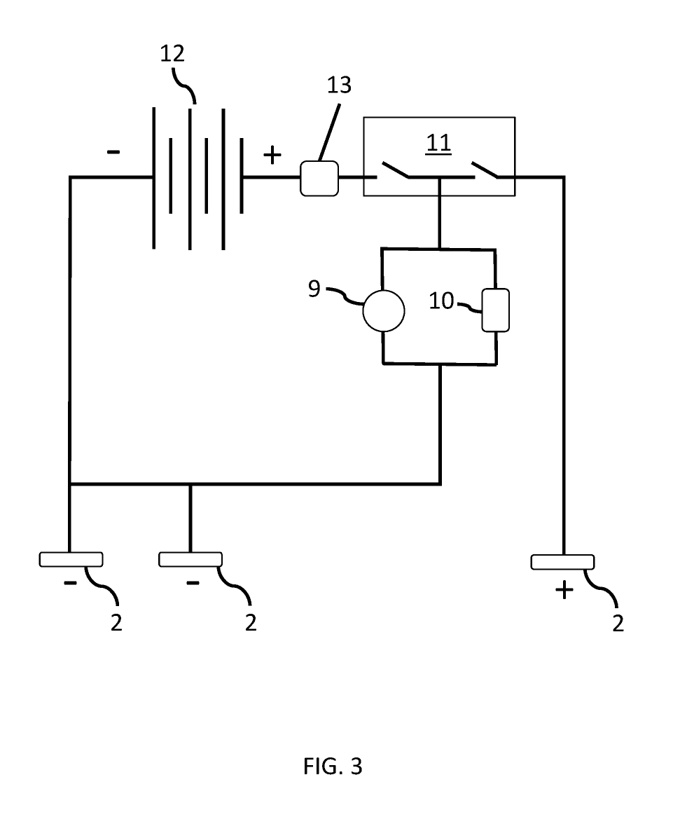

FIG. 3 is an electrical schematic of Battery Pack 1. Battery 12 is connected to Conductive Connectors 2, shown on the negative pole of Battery 12. Positive pole of Battery 12 is, on the positive side, shown connected to Fuse 13. Fuse 13 is connected through Battery On/Off Switch 11 to Conductive Connector 2, shown as the positive pole, and isolating/connecting Power Indicator 9 and Low Voltage Indicator 10, connected through to the negative pole of Battery 12.

Battery 12 may be of any type rechargeable battery or cell. Preferred types include Lithium-ion batteries of all types such as the Lithium ion lithium cobalt oxide battery (ICR), Lithium ion manganese oxide battery (IMR), Lithium ion polymer battery, Lithium iron phosphate battery, and Lithium-titanate battery as examples. Such batteries as the Magnesium-ion battery, Nickel-cadmium battery, Nickel-cadmium battery vented cell type, Nickel hydrogen battery, Nickel-iron battery, Nickel metal hydride battery, NiMH battery, Nickel-zinc battery, Organic radical battery, Polymer-based battery, Polysulfide bromide battery, Potassium-ion battery, Rechargeable alkaline battery, Rechargeable fuel battery, Silicon air battery, Silver-zinc battery, Silver calcium battery, Sodium-ion battery, Sodium-sulfur battery, Sugar battery, Super iron battery, Deep cycle battery, VRLA battery, AGM battery, GEL battery, Lithium Air battery, and the so called UltraBattery are also preferred.

Associated circuitry commonly required for the various battery types is not shown but is embodied by association. Battery manufacturers commonly supply and internally equip batteries with the safety and control electronics required for the desired operation and operational safety within the cell or battery pack.

Fuse 13 is a safety device that limits the current from Battery 12 in the event a predetermined current threshold is exceeded. Fuse 13 may be selected to be a single use fuse element such as a glass fuse, a mechanical circuit breaker, or an electronic circuit to limit the current either on a short, long term or resettable basis. A polymeric positive coefficient temperature device, a PPTC, commonly known as a resettable fuse is a preferred embodiment for this function. A PTC thermistor is also a preferred embodiment for this functional component.

The Battery On/Off Switch 11 is configured as a Double Pole Single Throw (DPST) switch to disconnect the Battery 12 from all loads. Other switching arrangements are well known in the art and are not shown but included by reference.

Power Indicator 9 is a power indicator and is preferred as an LED or other low current optical indicator with associated circuitry such as a resistor or transistor as required. An audio, vibrating or other indicator is a preferred embodiment as best fits the intended environment and application of the invention. A blinking or cyclic optical indicator such as an LED or lamp of any color as suited to the operating environment is a preferred embodiment.

Low Voltage Indicator 10 is a low voltage indicator to signal that the Battery Pack 1 will need to be changed. This indicator is preferred as an LED that increases in brightness as the battery voltage approaches the desired minimum voltage level, at which point the LED is at its maximum brightness.

The LED may be a steady on or blinking light as desired, and it is a preferred embodiment that the user can select this feature. Alternately the LED may come to full brightness once a minimum determined voltage level is reached. Ramping or blinking brightness levels as a signal of Battery Pack 1 exchange being required is a preferred embodiment.

An audio or vibratory signal indicating Battery Pack 1 exchange being required is a preferred embodiment, both as an increasing or decreasing or alternating signal indicative of an attained or approach to a set minimum voltage level. A vibrating signal indicating Battery Pack 1 exchange being required being detectable by the body part the Band 3 is attached to is a preferred embodiment.

The Battery Pack Connector Magnets 2 both mechanically and electrically attach Battery Pack 1 to Band 3 through Band Magnetic Connectors 7 and transfers electrical power through Band Magnetic Connectors 7 to the Integrated Controller 4 or other electronics as configured.

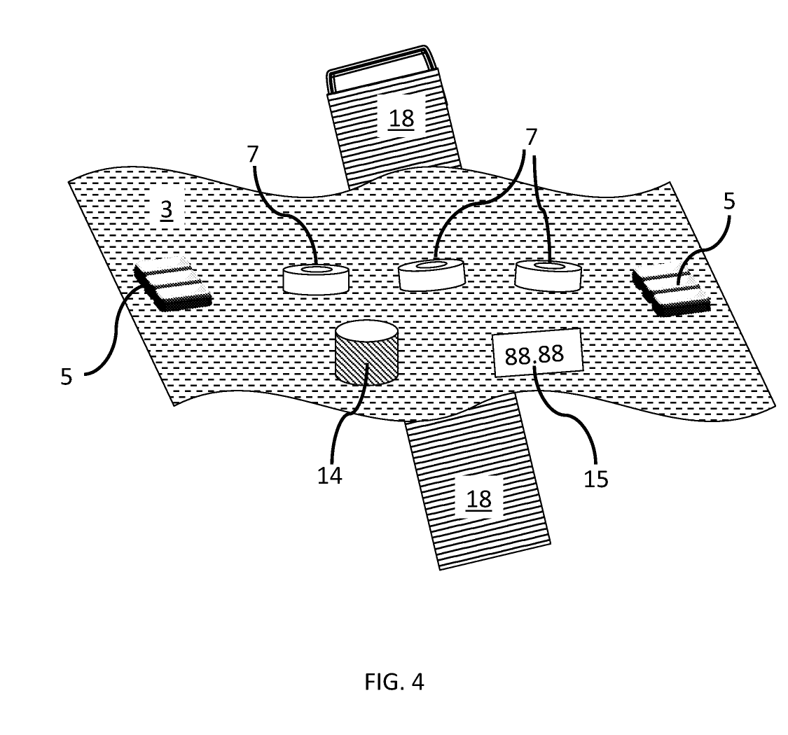

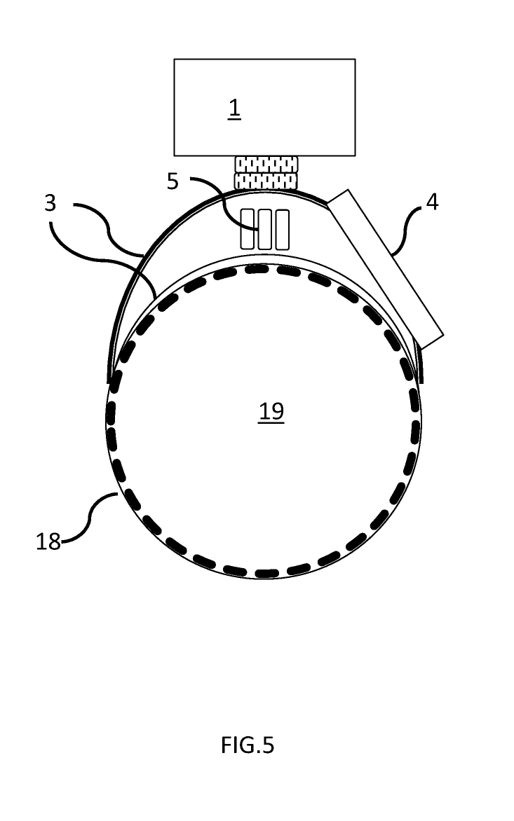

FIG. 4 illustrates the Strap 18 attached to the Band 3 with extensions to facilitate wrapping around the retaining structure, such as an arm or leg, that retain the Band 3, the Band 3 then conforming to the retaining structure by being flexible. The Band 3 contains all the electronics and associated cabling, wiring and interconnects as necessary to facilitate all electrical and electronic operations. The Band 3 contains all associated electronics and wiring as required, and has a surface away from the retaining structure that is selected to be durable and a surface in contact with the retaining structure selected to accommodate the desired use. For example, if the retaining structure is a bare arm, the Band 3 surface in contact with the arm is preferred to be comfortable and durable. The Band 3 may also be integrated into a clothing item such as a shirt, pants or vest, or attached with Velcro or other similar means such as snaps or buttons, negating the need for the Strap 18. The Band 3 may be suspended from the neck or shoulder by a band or lanyard as desired.

The Band 3 is preferred to be flexible enough to conform the body part such as a leg or arm, but stiff enough to maintain the required alignment and separation of Band Magnetic Connectors 7 and Power Output Connectors 5.

The components Band Magnetic Connectors 7, Power Output Connectors 5, Power Level Control 14, Display 15, Integrated Controller 4, Strap 18 are all attached and mechanically interconnected through the Band 3.

The Band Magnetic Connectors 7 are mounted to the flexible Band 3 so they may move and accommodate any mismatch when Battery Pack 1 is attached. Mechanical flexibility is provided by Band 3 relieving stress on the Battery Pack Connector Magnets 2 facilitating incidental motion of the Battery Pack 1 relative to the Band 3. This alignment flexibility provided by Band 3 assures mechanical alignment is correct, and that assures a proper electrical connection.

The Power Output Connectors 5 are magnetic conductors similar to Band Magnetic Connectors 7 in that they are conductive and magnetic. The Power Output Connectors 5 are electrically conductive magnets coated with an electrically conductive material that is resistive to corrosion, scratching and chipping. Preferred electrically conductive coatings include such materials as nickel, copper, gold, zinc, silver, chrome, metals, any metallic conductor, conductive plastics, conductive rubbers, and conductive resins and epoxies singly or in any combination. The Power Output Connectors 5 have a minimum of two magnetic conductors, with three magnetic conductors a preferred configuration providing for mechanical reversibility while maintaining proper electrical polarities for power transfer. The magnetic and electrical polarities are chosen to accommodate mechanical connection and power transfer to Cable Connector 6.

The Power Output Connectors 5 are electrically connected by the conductors contained with Band 3. The Power Output Connectors 5 must be flexible mounted so they may move and accommodate any mismatch when Cable Connector 6 not shown is attached. Mechanical flexibility is provided by Band 3 relieving stress on the Power Output Connectors 5 facilitating incidental motion of the Cable Connector 6 relative to the Band 3. This alignment flexibility provided by Band 3 assures mechanical alignment is correct, and that assurers a proper electrical connection. The Power Output Connectors 5 are preferred to be provided front and back of Band 3.

The Band 3 accommodates the mounting and integration of Integrated Controller 4, Integrated Controller 4 being an integrated electronic display and controller. Alternatively a mechanical control such as a potentiometer with a knob for control is represented by Power Level Control 14. The power level selected by rotating Power Level Control 14 is shown represented as a power, current or voltage readout as desired is displayed on Display 15. The present invention accommodates integrated control inputs and readouts as required for the particular application.

An integrated foot switch is a preferred embodiment of the present invention and its receiver function is integrated into the Band 3 to start and stop electrical power to the load via wireless control as required for the desired application.

FIG. 5 illustrates a cross section of a Battery Pack 1, Band 3, Strap 18, Integrated Controller 4, mounted and a Power Output Connectors 5. This is a typical configuration if mounted on a Body Part 19 such as an arm or leg and illustrates the relative mechanical configuration and location of components.

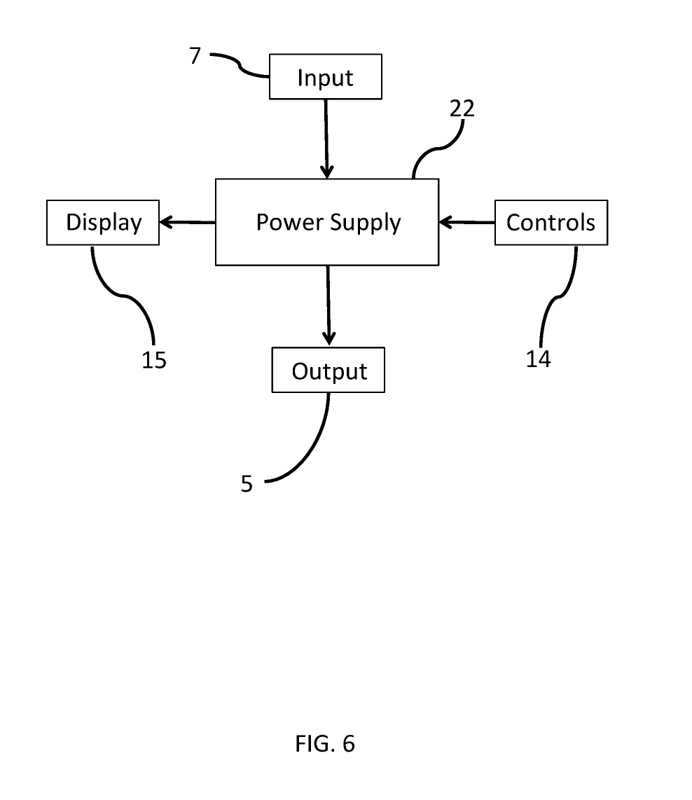

FIG. 6 is a functional diagram of the relationship between the various components in terms of electrical and electronic flow and connection. The INPUT, Band Magnetic Connectors 7, at the top of the diagram connects the Battery Pack 1 to the operational circuit. Electrical power flows into the POWER SUPPLY, Power Supply 22, preferred to be contained within the Band 3. Power Supply 22 contains and performs all power supply functions. The CONTROLS, Power Level Control 14, is shown with an input into Power Supply 22. The CONTROLS block is preferred to include and accommodate a wide variety of controls such as a foot switch, mechanical switch, touch pad, electronic signals, digital signals, logic signals and other types of control input as may be common to or integrateable with the present application. The selected power settings are displayed on the DISPLAY, Display 15. The CONTROLS and DISPLAY may be substituted by Integrated Controller 4. The OUTPUT receives the electrical power from the POWER SUPPLY and outputs to the Load 17 through the Power Output Connectors 5.

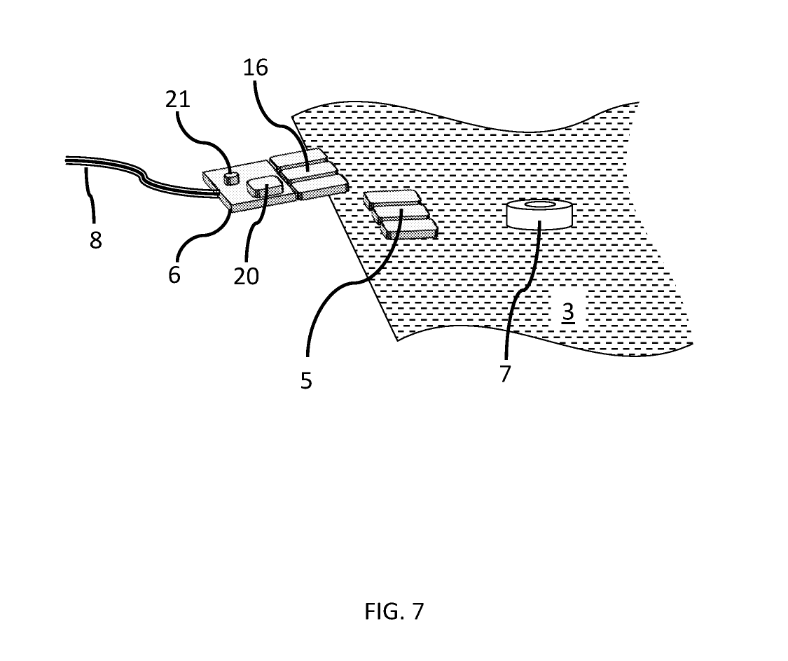

FIG. 7 illustrates the Power Output Connectors 5 mounted on the Band 3 just prior to contact with Cable Connector 6, here shown as further comprised of Cable Connector Magnets 16, Power Switch 20 and Power On/Off Indicator 21. Cable Connector Magnets 16 are electrically conductive magnets coated with an electrically conductive material that is resistive to corrosion, scratching and chipping. Preferred electrically conductive coatings include such materials as nickel, copper, gold, zinc, silver, chrome, metals, any metallic conductor, conductive plastics, conductive rubbers, and conductive resins and epoxies singly or in any combination. The Cable Connector Magnets 16 have a minimum of two magnetic conductors, with three magnetic conductors a preferred configuration providing for mechanical reversibility of the assembly while maintaining proper magnetic polarities for mechanical connection and proper electrical polarities for power transfer. The magnetic and electrical polarities are chosen to accommodate mechanical connection and power transfer to Cable Connector 6. Cable Connector 6 is further equipped with Power Switch 20 to turn on or turn off power transfer from Cable Connector Magnets 16 to Cable 8. In this manner the operation of the Load 17 not shown can be readily stopped or started to facilitate the desired operation. The Power Switch 20 is preferred as a switch of any type that can close or open an electrical circuit. Preferred switch types include but are not limited to circuit breaker, mercury switch, wafer switch, DIP switch, surface mount switch, reed switch, wall switch, toggle switch, in□line switch, push-button switch, rocker switch, micro switch, magnetic switch, electronic switch, optical switch, touch switch, relay switch, knife switch, transfer switch, multiway switch and any switching type or technology that can close or open a circuit in any degree and in any manner. It is a preferred embodiment that the Power Switch 20 be waterproof or completely immerseable for operation and cleaning. The switch is preferred in any configuration to include but not limited to SPST, SPDT, SPCO, DPST, DPDT, DPCO and any and all other configurations and orientations as required. The Power On/Off Indicator 21 indicates the power condition of the Cable Connector 6, and, in turn, the on or off condition of the Load 17. The Power On/Off Indicator 21 is preferred to be an optical indicator such as an LED. The Power On/Off Indicator 21 is also preferred to be an optical, vibratory or audio indicator of any type or combination, including concurrent audio, vibratory and optical.

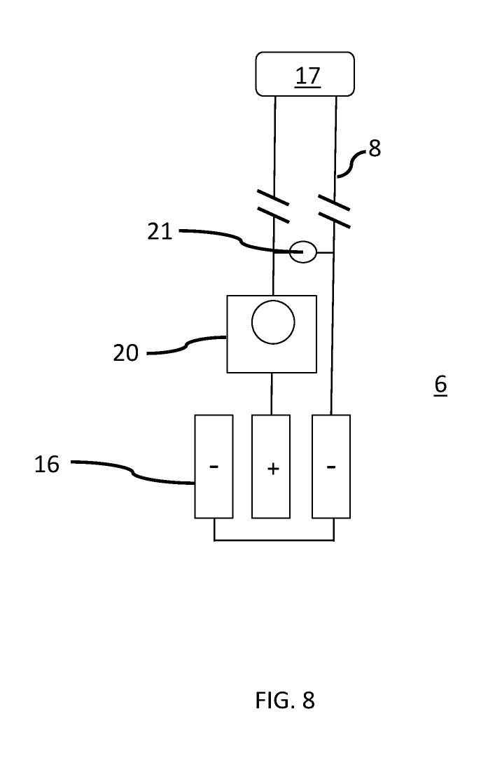

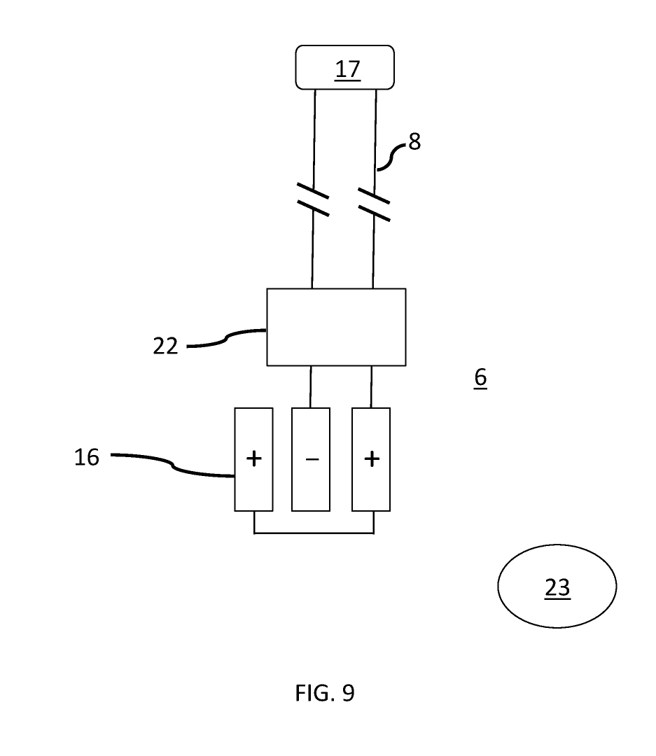

FIG. 8 details the Cable Connector 6 components comprised of Cable Connector Magnets 16, Power On/Off Indicator 21, Power Switch 20, Cable 8, and Load 17, and their electrical and functional connection to each other. Cable Connector Magnets 16 are shown being comprised of three magnetic elements as previously described. The two outermost elements are the same magnetic polarity and orientation, while the middle element is of the opposite magnetic polarity and orientation. The outermost magnetic elements are noted as negative, indicating they carry the negative electrical potential in a DC configuration, and the middle magnetic element is noted as positive, or plus, indicating it carries the positive elective electrical potential in a DC configuration. The magnetic orientations also assure a correct mechanical and electrical connection in Alternating Current operation as well. The plus, or center, magnetic connector is shown connected to Power Switch 20. Power Switch 20 has been previously described and controls the on or off power condition of the Cable Connector 6. The Power On/Off Indicator 21 indicates to the operator the status of on or off electrical condition of Cable 8, and of the Load 17 when connected.

All magnets and magnetic devices and implements in the foregoing description include compositions of all know magnetic materials, and preferably includes materials containing an alloy of neodymium, iron and boron to form the Nd2Fe14B tetragonal crystalline structure commonly referred to as neodymium. It is a preferred embodiment that the electrically conductive properties of neodymium provide significant electrical conductivity and facilitate miniaturization of the device. All magnets are preferred to be covered in a conductive and mechanically sound overcoat.

This present innovation facilitates the seamless “quick switch” of battery packs, providing the user an un-tethered “wireless” system to utilize during the process of powering the load, and adds no significant additional time to the work at hand.

The various terms are used interchangeable to facilitate clarity in the various descriptions as appropriate, and conductive coatings are functionally interchangeable with conductive plating or plate, the terms battery and current source are used interchangeably for clarity, and magnets covered in a conductive material include any conductive material.

While the present invention has been described in terms of various specific embodiments, those skilled in the art will recognize that the invention can be practiced with considerable modification within the spirit and scope of the variations, combinations, and equivalents of the specific embodiment, method, and examples herein revealed. The invention should therefore not be limited by the above described embodiments, but as it is set forth in the claims below.

1. The method of a moveable conductive magnet comprised of a conductive magnet, a fastener, a structural substrate, a formed cavity and a flexible electrical conductor facilitating constrained movement and motion of the moveable conductive magnet together comprising an electrical, magnetic and mechanical connection means.

2. The method of claim 1 wherein the moveable conductive magnet is further comprised of neodymium encased in a conductive structural overcoat.

3. The method of claim 1 further comprising mechanical and conductive means to include a spring, springs, spring material, foam, rod, wire, conductive elastomers, conductive plastic, conductive mechanical constraint, bearing and mechanical means inclusive of mechanically flexible electrical conductors.

4. The method of claim 1 further comprising a plurality of moveable conductive magnetic connectors.

5. The method of claim 1 wherein the conductively clad magnet is a conductive magnetic material comprised of a magnetic core covered by electrically conductive cladding materials further facilitating constrained rotary, rocking, linear, reciprocating and oscillatory motion of the clad magnet in all dimensions, said motion being constrained by a formed cavity in the magnet and a fastener.

6. The method of claim 1 further comprising a conductive magnet retained by a fastener configured as a center post attached to the structural substrate facilitating freedom of movement of the conductive magnet along the post, the fastener further comprising a stop mechanism at the head of the post and opposite the structural substrate retaining the conductive magnet on the post, the post head restraining further movement of the conductive magnet, said conductive magnet being electrically connected by a conductor.

7. The moveable conductive magnet of claim 1 wherein the electrically conductive materials are electrically connected to a single pole of the battery or alternating electrical power source.

8. The method of claim 1 wherein the moveable conductive magnet is mechanically constrained and electrically connected by only a conductive mechanical spring.

9. The method of claim 1 wherein multiple separate electrical conduction paths are provided on the electrically insulated connective structure of the moveable conductive magnet.

10. The method of a reversible magnetically connected battery pack comprised of one or a plurality of batteries electrically and mechanically attached through three conductive magnets together comprising a battery pack, the battery pack magnetically and electrically connected to a battery pack receiver comprising three conductive magnets facilitating discharge to an electrical load, and a battery power pack charger receiver through three conductive magnets magnetically and electrically connecting to an electrical source for charging, the outermost two conductive magnets being connected to the electrically opposite polarity of the electrical polarity connected to the center conductive magnet.

11. The method of claim 10 wherein the battery pack, battery power pack receiver, and power pack charger receiver are all facilitated with conductive magnetic connectors.

12. The method of claim 10 wherein the battery pack and battery power pack receiver or battery power pack charger receiver comprises conductive magnetic connectors and the opposite connective component comprises a conductive magnetic material to include all magnetic conductors.

13. The method of claim 10 further comprising a safety switch, a flow sterilization system containing a cleaning gas, an ozone gas sterilization system, an ultraviolet light, ionized gas, ethylene oxide, sterilizing gas, chlorine, ionized liquid, materials of high or low pH to include sodium hypochlorite bleach mist and other preferred sterilizing agents, hot air, dry air, room air and any gas or combination of gas.

14. The method of claim 10 wherein the battery pack and battery pack receiver are arranged in a conformal manner including wrapping to the arm, lower arm and wrist.

15. The method of electrical and mechanical connection of a battery power pack by conductive magnet means through a wrist mounted battery pack receiver on which is mounted a tool power control and monitor to a hand tool including power tools, a tattoo machine, electrical tools, electric toys, an artistic tool, a communication device, a weapon, and an electronic device of any type requiring portable electrical power of any frequency or potential.

16. The method of claim 15 wherein the electrical connection is through a conductive reversible magnetic cable connector.

17. The method of claim 15 wherein the battery pack, battery pack receiver, power control and cabling is mounted on the vehicle, machine, device, toy, tool, gun and any device requiring electrical power of any kind, on or in the body, or on or in clothing.

18. The method of claim 15 further incorporating twist to release action relieving magnetic connection being further facilitated by magnetically repelling removal magnets.

19. The method of claim 15 further comprising a reversible magnetically connected battery cartridge and receiver comprising a battery pack comprising one or a plurality of batteries, the battery pack in a housing, said housing comprising a mounting surface, three electrically conductive magnets attached to the housing in a linear fashion and in a straight line, each magnet with a conduction lead attached to one pole of the battery pack, the outside magnets attached to one electrical pole of the battery pack and the center magnet attached to the opposite pole of the battery pack, the battery cartridge is physically reversible without changing the positions of the electrical poles, provides a safety switch to energize the batteries and magnets when inserted, the battery cartridge supported by mechanical action of the magnets and a reversible magnetically connectable battery cartridge receiver comprising three electrically conductive magnets.
